(19) United States
(12) Patent Application Publication
(10) Pub. No.: US 2015/0198964 A1
(43) Pub. Date: Jul. 16, 2015

(54) MULTIDIRECTIONAL INPUT DEVICE

(71) Applicant: HOSIDEN CORPORATION, Yao-shi (JP)

(72) Inventor: Mitsuhiro ASANO, Yao-shi (JP)

(73) Assignee: HOSIDEN CORPORATION, Yao-shi (JP)

(21) Appl. No.: 14/576,427

(22) Filed: Dec. 19, 2014

(30) Foreign Application Priority Data
Jan. 16, 2014 (JP) 2014-5940

(51) Int. Cl. G05G 9/047; G05G 5/05

(52) U.S. Cl. CPC G05G 9/047; G05G 5/05; G05G 2009/04744; G05G 2009/04751; G05G 2009/04777

(57) ABSTRACT

A multidirectional input device includes a mount, an operation lever, first and second interlocking members, and first and second detectors. The mount includes a support face of generally spherical convex shape. The operation lever is slidably supported on the support face. The first interlocking member receives the operation lever therethrough and is movable in a first direction in an arc-like manner in accordance with movement in the first direction of the operation lever. The second interlocking member crosses the first interlocking member, receives the operation lever therethrough, and is movable in a second direction in an arc-like manner in accordance with movement in the second direction of the operation lever the second direction crossing the first direction. The first detector can detect a direction and an amount of movement of the first interlocking member. The second detector can detect a direction and an amount of movement of the second interlocking member.

### CROSS-REFERENCE TO RELATED APPLICATIONS

The present application claims priority under 35 U.S.C. §119 of Japanese Patent Application No. 2014-5940 filed on Jan. 16, 2014, the disclosure of which is expressly incorporated by reference herein in its entity.

### BACKGROUND OF THE INVENTION

1. Technical Field

The invention relates to multidirectional input devices.

2. Background Art

Japanese Patent Application Laid-Open No. 2001-75727 describes a conventional multidirectional input device including a case, an operation lever, first and second rotary members, and first and second detectors. The case has a bottom plate and a boss standing on the bottom plate. The lower end of the operation lever is supported on the boss to allow the operation lever to be tilted. The first and second rotary members are rotatably supported on the case and arranged orthogonal to each other inside the case. The operation lever passes through the first and second rotary members. When the operation lever is tilted, the first and/or second rotary member rotates. The first detector detects the direction and amount of the rotation of the first rotary member. The second detector detects the direction and amount of the rotation of the second rotary member.

### SUMMARY OF INVENTION

Generally, this type of multidirectional input devices are installed in portable communication terminals, controllers of game machines, or the like. As portable communication terminals and controllers of game machines are multi-functionalized and downsized, there is a demand for downsized multidirectional input devices.

Downsizing the above conventional multidirectional input device leads to reduced amount of tilt (reduced rotation radius) of the operation lever, making it difficult to provide desirable operational feel. Also, such decreased amount of tilt causes reduction of amounts of rotation (reduction of rotation radius) of the first and second rotary members, making it difficult for the first and second detectors to detect the rotation of the first and second rotary members. Therefore, downsizing the conventional multidirectional input device should results in lower accuracy in detecting operations of the operation lever.

In view of the above circumstances, the invention provides a multidirectional input device including an operation lever that can provide an improved operational feel. The invention can also improve accuracy in detecting operation of the operation lever.

A multidirectional input device according to an aspect of the invention includes a mount, an operation lever, first and second interlocking members, and first and second detectors. The mount includes a support face of generally spherical convex shape. The operation lever is slidably supported on the support face. The first interlocking member is configured to receive the operation lever therethrough and be movable in a first direction in an arc-like manner in accordance with movement in the first direction of the operation lever. The second interlocking member is configured to cross the first interlocking member, receive the operation lever therethrough, and be movable in a second direction in an arc-like manner in accordance with movement in the second direction of the operation lever, the second direction crossing the first direction. The first detector is configured to detect a direction and an amount of movement of the first interlocking member. The second detector is configured to detect a direction and an amount of movement of the second interlocking member.

The multidirectional input device of this aspect has at least the following technical features. First, the device provides an improved operational feel of the operation lever for the following reasons. The operation lever slides on the generally spherically convexed support face of the mount, so that the operation lever can move along a longer route (rotate at a longer radius). Second, the multidirectional input device can detect operations of the operation lever with improved accuracy for the following reason. The first and second interlocking members can move in an arc-like manner in accordance with movement of the operation lever, so that they each can move along a longer route (rotate at a longer radius).

The operation lever may include a support disposed between the first interlocking member and the mount. The first interlocking member may be supported on the support of the operation lever and movable in the first direction in an arc-like manner along the support face of the mount. The first interlocking member may have a support face of arc shape extending in the second direction. The second interlocking member may be slidable in the second direction in an arc-like manner on and along the support face of the first interlocking member.

the multidirectional input device of this aspect has an advantageously small dimension in the overlapping direction of the first and second interlocking members of the device. This is because the second interlocking member is slidably disposed on the support face of the first interlocking member.

Alternatively, the first interlocking member may not be supported on the support of the operation lever but slidable in the first direction in an arc-like manner on and along the support face of the mount. The multidirectional input device of this aspect has an advantageously small dimension in the overlapping direction of the first and second interlocking members of the device. This is because the first interlocking member is slidably disposed on the support face of the mount and the second interlocking member is slidably disposed on the support face of the first interlocking member.

The multidirectional input device may further include a first slider and a second slider. The first slider may be movable in the first direction in accordance with movement of the first interlocking member. The first slider may include a first projection extending in the second direction. The second direction may be substantially orthogonal to the first direction. The second slider may be movable in the second direction in accordance with movement of the second interlocking member. The second slider may include a second projection extending in the first direction. The first interlocking member may include a first recess extending in a third direction. The third direction may be substantially orthogonal to the first direction and the second direction. The first projection of the first slider may be engaged in the first recess movably in the third direction. The second interlocking member may include a second recess extending in the third direction. The second projection of the second slider may be engaged in the second recess movably in the third direction.

The first slider may alternatively include a first recess extending in the third direction. The third direction may be substantially orthogonal to the first direction and the second direction. The second slider may alternatively include a second recess extending in the third direction. The first interlocking member may alternatively include a first projection extending in the second direction, and the first projection of the first interlocking member may be engaged in the first recess movably in the third direction. The second interlocking member may alternatively include a second projection extending in the first direction, and the second projection of the second interlocking member may be engaged in the second recess movably in the third direction.

In the multidirectional input device of these aspects, arc-like movements of the first and second interlocking members will not apply load to the part connecting between the first interlocking member and the first sliders (i.e. the first projection and the first recess) or to the part connecting between the second interlocking member and the second slider (i.e. the second projection and the second recess). This is because of that the first and second recesses extend in the third direction, and the first and second projections are respectively engaged in the first and second recesses movably in the third direction. Further, it is easy to couple the first interlocking member to the first slider and couple the second interlocking member to the second slider, only requiring engagement of the first and second projections with the first and second recesses, respectively.

The above multidirectional input device may further include a first guide and a second guide. The first guide may be configured to guide the first interlocking member movably in the first direction in an arc-like manner. The second guide may be configured to guide the second interlocking member movably in the second direction in an arc-like manner. In the multidirectional input device of this aspect, the first and second interlocking members can move in a stable manner because they are guided by the first and second guides.

The above multidirectional input device may further include a body. The body may include first and second housing portions and first and second guides. The first housing portion may house the first slider movably in the first direction. The second housing portion may house the second slider movably in the second direction. The first guide may be located at one side of the third direction relative to the first housing portion and may be configured to guide the first interlocking member to move in the first direction in an arc-like manner. The second guide may be located at one side of the third direction relative to the second housing portion and may be configured to guide the second interlocking member to move in the second direction in an arc-like manner.

In the multidirectional input device of this aspect, the first and second interlocking members can move in a stable manner because they are guided by the first and second guides.

The above multidirectional input device may further include a base and an elastic body. The elastic body may be interposed between the base and the mount, the elastic body supporting the mount in midair. In the multidirectional input device of this aspect, the operation lever is operated with a reduced load on the mount.

The elastic body may provide a biasing force to hold the support of the operation lever between the mount and the first interlocking member. In the multidirectional input device of this aspect, the operation lever can slide in a stable manner.

The operation lever may be movable in a third direction so as to depress the mount. The third direction may be substantially orthogonal to the first direction and the second direction. The mount as depressed may be movable against an elastic force of the elastic body. The multidirectional input device may further include a third detector configured to detect the movement of the operation lever.

The first detector may be configured to detect a direction and an amount of movement of the first interlocking member by detecting a direction and an amount of movement of the first slider. The second detector may be configured to detect a moving direction and a moving amount of movement of the second interlocking member by detecting a moving direction and a moving amount of movement of the second slider.

### BRIEF DESCRIPTION OF DRAWINGS

FIG. 1A is a front, top, right side perspective view of a multidirectional input device according to a first embodiment of the invention;

FIG. 1B is a front, bottom, left side perspective view of the input device;

FIG. 2A is a cross-sectional view of the input device taken along line 2A-2A in FIG. 1A;

FIG. 2B is a cross-sectional view of the input device taken along line 2B-2B in FIG. 1A;

FIG. 2C is a cross-sectional view of the input device taken along line 2C-2C in FIG. 1A;

FIG. 2D is a cross-sectional view of the input device taken along line 2D-2D in FIG. 1A;

FIG. 2E is a cross-sectional view of the input device taken along line 2E-2E in FIG. 1A;

FIG. 3A is a front, top, and right side perspective view of the input device, with a key top of an operation lever and a cover removed;

FIG. 3B is a front, top, and right side perspective view of the input device, with the key top of the operation lever, the cover, and a body removed;

FIG. 4A is a front, top, right side perspective view of the body of the input device; and

FIG. 4B is a rear, bottom, right side perspective view of the body of the input device.

### DESCRIPTION OF EMBODIMENT

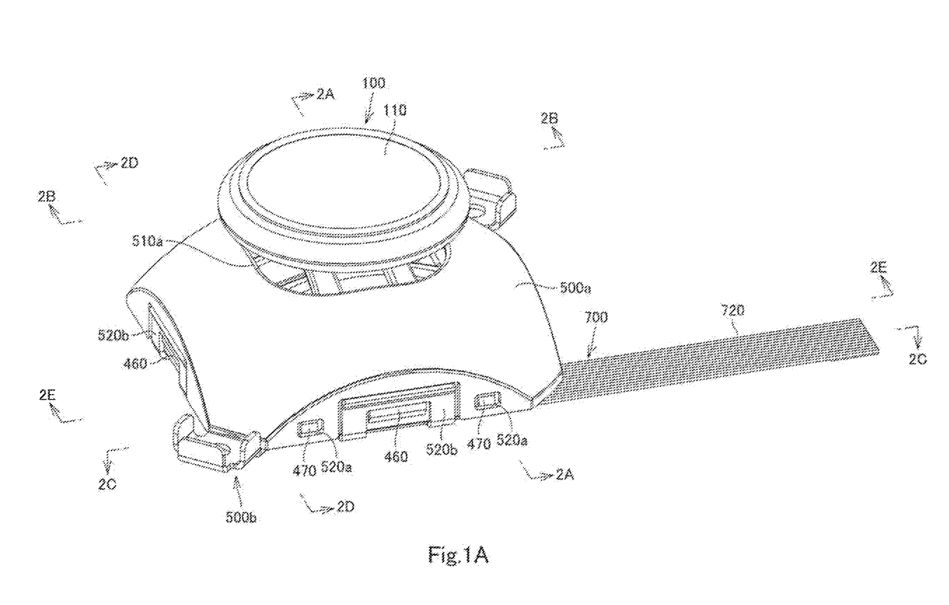

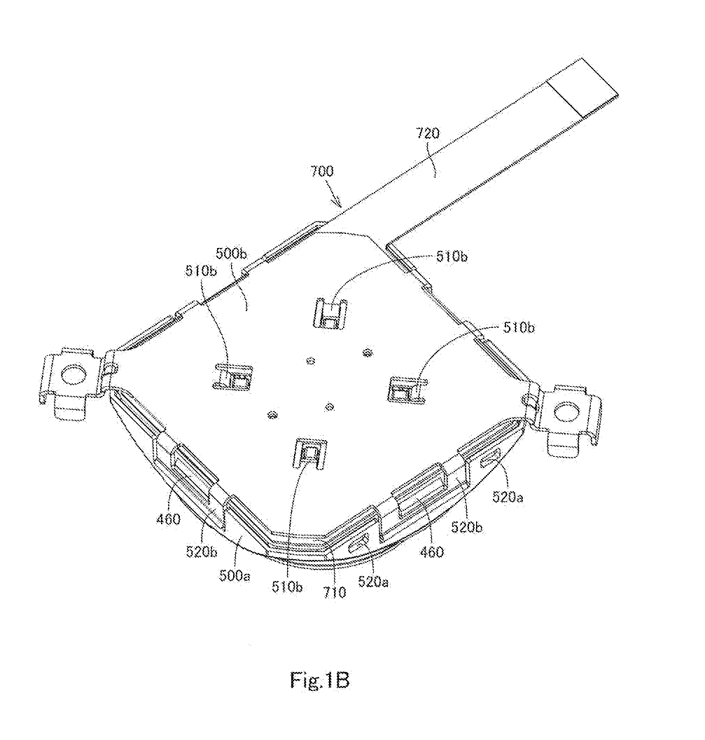

A multidirectional input device according to a first embodiment of the invention will be described below with reference to FIGS. 1A to 4B.

### First Embodiment

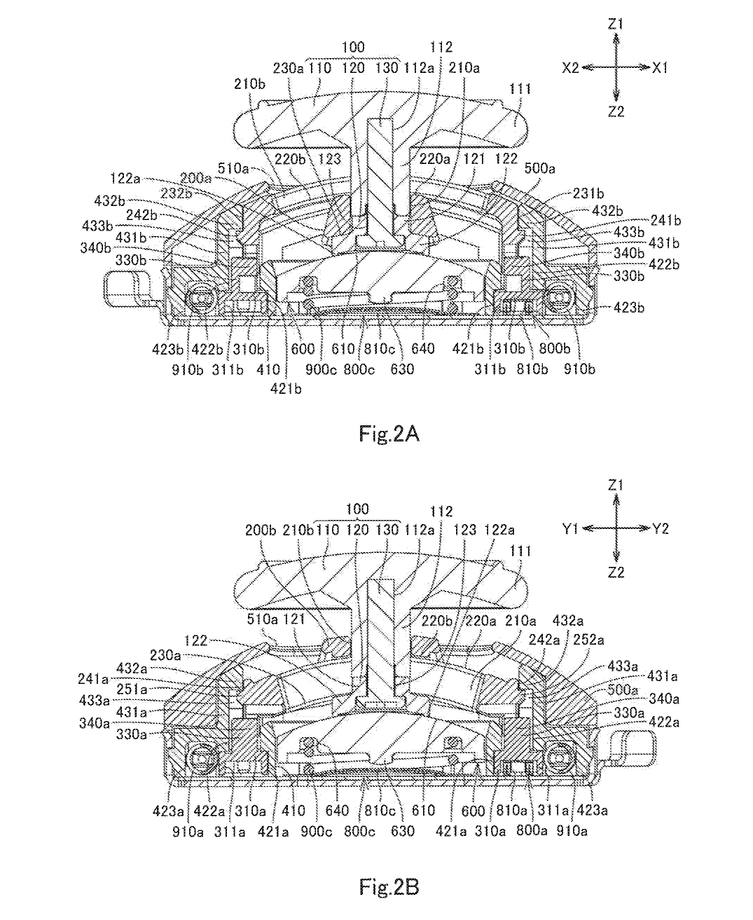

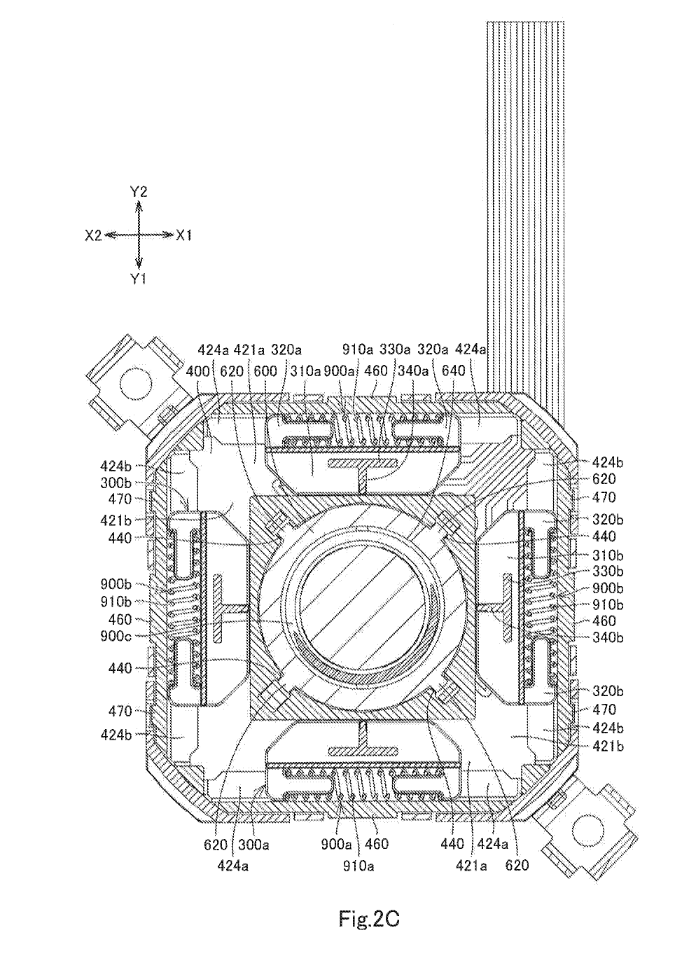

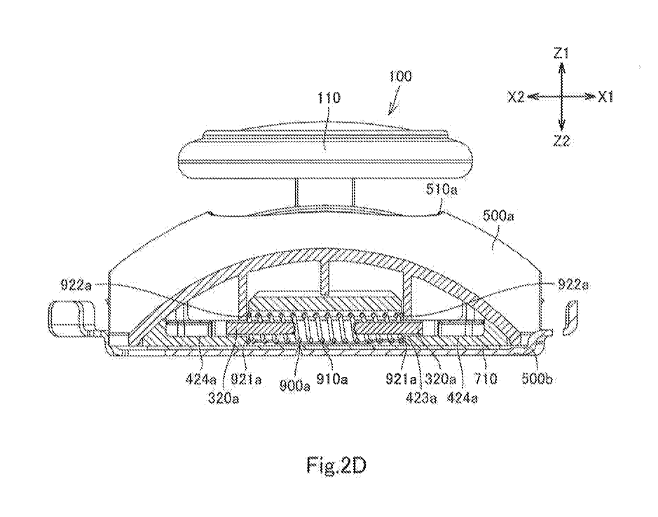

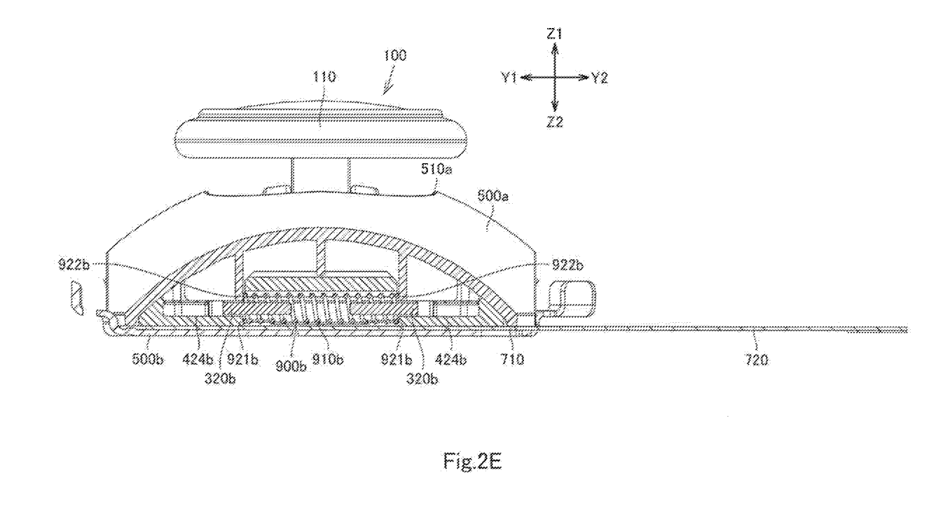

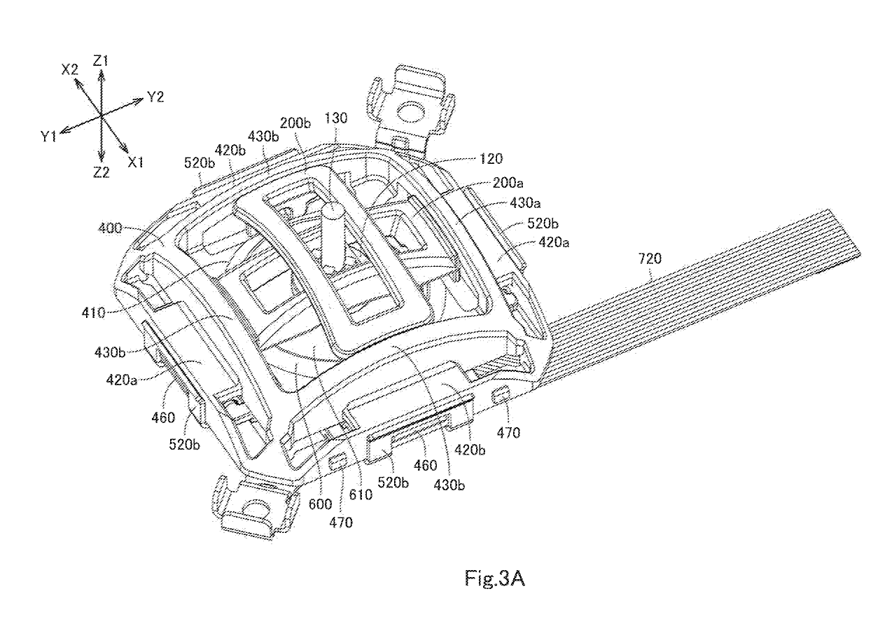

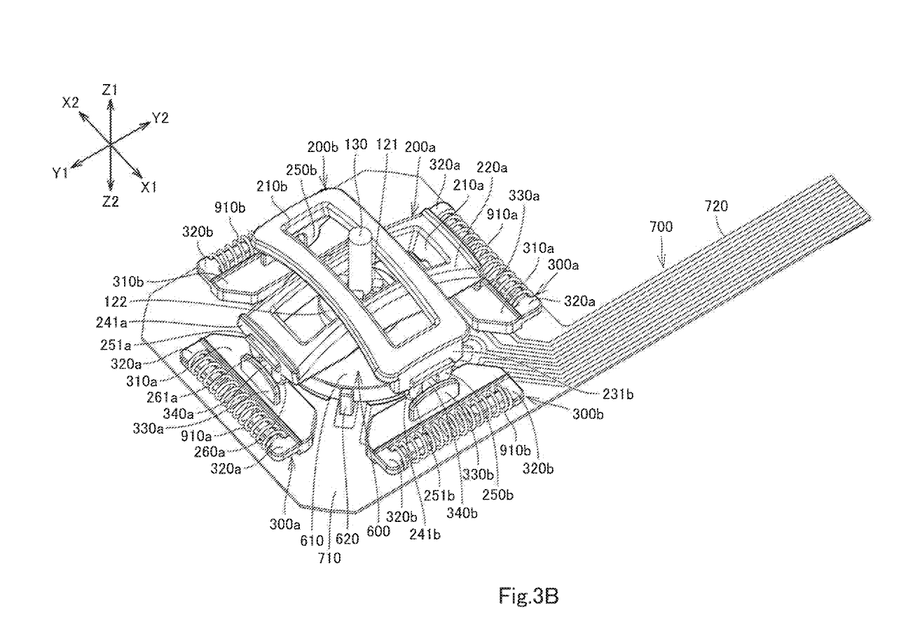

The multidirectional input device illustrated in FIGS. 1A to 4B includes an operation lever 100 that is operable from an neutral position in any radially outward direction and also in a Z2 direction to perform corresponding input. The input device includes the operation lever 100, first and second interlocking members 200a and 200b, a pair of first sliders 300a, a pair of second sliders 300b, a body 400, a cover 500a, a frame 500b, a mount 600, a circuit board 700, first, second, and third detectors 800a, 800b, 800c, a pair of first return mechanisms 900a, a pair of second return mechanisms 900b, and an elastic member 900c. These constituents of the multidirectional input device will be described below in detail. An X1-X2 direction indicated in FIGS. 2A, 2C, 2D, and 3A to 3B corresponds to the first direction in the claims. A Y1-Y2 direction indicated in FIGS. 2B, 2C, and 2E to 3B corresponds to the second direction in the claims. A Z1-Z2 direction indicated in FIGS. 2A to 3B is the height direction of the multidirectional input device and corresponds to the third direction in the claims. The Y1-Y2 direction is substantially orthogonal to the X1-X2 direction. The Z1-Z2 direction is substantially orthogonal to the Y1-Y2 direction and the X1-X2 direction.

As illustrated in FIGS. 2A to 2C, the mount 600 is a generally cylindrical member of an insulating resin. The mount 600 includes a support face 610, four guide projections 620, a protrusion 630, and a ring hole 640. The guide projections 620 are arranged around the outer peripheral face of the mount 600, spaced at 90° intervals to radially extend from the mount 600. The support face 610 is the upper face (Z1-direction end face) of the mount 600 and is of generally spherically convex shape. The protrusion 630 is a generally cylindrical protrusion in the center of the lower face (Z2-direction end face) of the mount 600 and extends in the Z1-Z2 direction. The ring hole 640 is a bottomed ring-shaped hole in the peripheral portion of the lower face of the mount 600.

As best illustrated in FIGS. 2A and 2B, the operation lever 100 is supported on the support face 610 of the mount 600 so as to be slidable from the neutral position. The operation lever 100 can also move in the Z1-Z2 direction from the neutral position together with the mount 600. As illustrated in FIGS. 2A and 2B, the neutral position of the operation lever 100 of the first embodiment is a position where the centers of shafts 112, 121 (to be described) of the operation lever 100 are located along the vertical line passing through the vertex of the support face 610 of the mount 600 and the first and second interlocking members 200a, 200b abut first and second guides 430a, 430b (to be described) of the body 400.

The operation lever 100 includes a key top 110, a slidable part 120, and an attachment member 130. The slidable part 120 includes the shaft 121, a support 122, and a through-hole 123. The support 122, generally discoid, is disposed between the support face 610 of the mount 600 and the first interlocking member 200a. The upper face (Z1-direction end face) of the support 122 has a generally spherical convexed shape, corresponding to the shape of the support face 610 of the mount 600. The lower face (Z2-direction end face) of the support 122 is provided with a ring-shaped protrusion 122a. The protrusion 122a is slidable along the support face 610 of the mount 600. This arrangement can reduce friction between the slidable part 120 and the support face 610 when the slidable part 120 slides on and along the support face 610. The shaft 121 is a square prism extending from the center of the upper face of the support 122. The shaft 121 has outer dimensions in the X1-X2 and Y1-Y2 directions that are equal to those of the shaft 112 but smaller than those of the support 122. The through-hole 123 extends in the Z1-Z2 direction through the central portion of the slidable part 120.

The key top 110 includes a discoid operable portion 111 and the shaft 112. The shaft 112 is of generally square prism shape extending in the Z1-Z2 direction from the center of the lower face (Z2-direction end face) of the operable portion 111. The shaft 112 is attached to the upper face (Z1-direction end face) of the shaft 121 of the slidable part 120. The shaft 112 has an attachment hole 112a in communication with the through-hole 123.

The attachment member 130 is a metal screw. The attachment member 130 passes through the through-hole 123 of the slidable part 120 and screws in the attachment hole 112a of the shaft 112 of the key top 110. The attachment member 130 serves to attach the slidable part 120 to the key top 110. The attachment member 130, made of metal, also serves to reinforce the operation lever 100. The attachment member 130 may be a screw of plastic material instead.

The circuit board 700 may be a flexible printed circuits (FPC) or may be a PET-based circuit board. As best illustrated in FIG. 3B, the circuit board 700 includes a board body 710 (corresponding to the base in the claims) and a connection portion 720. The board body 710 is a rectangular member having a central portion, a Y1-direction end, a Y2-direction end, an X1-direction end, and an X2-direction end. The connection portion 720 is contiguous with the board body 710. The connection portion 720 serves as an external connection portion connectable to e.g. a control part of an electronic device to install the multidirectional input device of the invention.

As best illustrated in FIGS. 2A and 2B, the elastic member 900c is a coil spring interposed between the central portion of the circuit board main body 710 and the mount 600 to support the mount 600 in midair. The Z1-direction end of the elastic member 900c is housed in the ring hole 640 of the mount 600. The elastic member 900c is compressed between the central portion of the board body 710 and the mount 600 in accordance with movement in the Z2 direction of the operation lever 100 and the mount 600. The elastic member 900c biases the mount 600 in the Z1 direction so as to restore the operation lever 100 to the neutral position.

As best illustrated in FIGS. 2A and 2B, the third detector 800c is a depression switch for detecting movement in the Z2 direction of the operation lever 100. The third detector 800c includes a movable contact 810c and a pair of first and second stationary contacts (not shown). The first stationary contact is formed on the center of the board body 710, and the second stationary contact surrounds the first stationary contact on the board body 710. The movable contact 810c is a metal plate of dome shape or arc shape that is convexed in the Z1 direction. The movable contact 810c is fixed on the board body 710 with an adhesive tape so as to be in contact with the second stationary contact. The apex of the movable contact 810c is disposed above and in spaced relation to the first stationary contact, under and in spaced relation to the protrusion 630 of the mount 600. When the apex of the movable contact 810c is depressed in the Z2 direction by the protrusion 630 of the mount 600, the movable contact 810c elastically deforms so that its apex is brought into contact with the first stationary contact. As a result, the pair of stationary contacts are brought into conduction with each other, and the third detector 800c can detect the movement in the Z2 direction of the operation lever 100.

As best illustrated in FIG. 3B, the first interlocking member 200a extends in the Y1-Y2 direction and is movable in an arc-like manner in the X1-X2 direction in accordance with movement in the X1-X2 direction of the operation lever 100. The first interlocking member 200a includes an elongated hole 210a, a support face 220a, an abuttable face 230a, guide faces 241a and 242a, guide projections 251a and 252a, and a pair of engagement portions 260a.

The support face 220a is the upper face (Z1-direction end face) of the first interlocking member 200a. The support face 220a extends in the Y1-Y2 direction in an arc-like manner. The abuttable surface 230a is the lower face (Z2-direction end face) of the first interlocking member 200a. The abuttable face 230a abuts the support 122 of the operation lever 100. In other words, the first interlocking member 200a is supported on the support 122 of the operation lever 100, in spaced relation to the support face 610 of the mount 600. This arrangement allows the first interlocking member 200a to move in the Z2 direction in response to the movement in the Z2 direction of the operation lever 100. The abuttable face 230a extends in the Y1-Y2 direction in an arc-like manner, i.e. it is concaved in a generally spherical shape corresponding to the shape of the support face 610 of the mount 600. This arrangement allows the support 122 to move in the Y1-Y2 direction along the abuttable face 230a of the first interlocking member 200a and the support face 610 of the mount 600.

The elongated hole 210a is a generally rectangular hole passing through the first interlocking member 200a in the Z1-Z2 direction and extends in the Y1-Y2 direction. The elongated hole 210a is slightly larger in X1-X2 direction dimension than each of the shafts 112, 121 of the operation lever 100. The shafts 112, 121 of the operation lever 100 are inserted through the elongated hole 210a so as to be movable in the Z1-Z2 and Y1-Y2 directions. In other words, the shafts 112, 121 of the operation lever 100 pass through the first interlocking member 200a in the Z1-Z2 direction. The elongated hole 210a of the first interlocking member 200a has an X1-direction inner wall and an X2-direction inner wall facing the shafts 112, 121 of the operation lever 100 in contact therewith or with narrow clearances therefrom. When the operation lever 100 is located at the neutral position, the shafts 112, 121 of the operation lever 100 regulate the positions of the X1-direction inner wall and the X2-direction inner wall of the first interlocking member 200a so as to maintain the first interlocking member 200a in its initial position. When the shafts 112, 121 press the X1-direction inner wall, the first interlocking member 200a is displaced from the initial position in the X1 direction in an arc-like manner. When the shafts 112, 121 presses the X2-direction inner wall, the first interlocking member 200a is displaced from the initial position in the X2 direction in an arc-like manner.

The guide face 241a is the Y1-direction end face of the first interlocking member 200a. The guide face 242a is the Y2-direction end face of the first interlocking member 200a. The guide projection 251a is provided on the guide face 241a. The guide projection 252a is provided on the guide face 242a. The guide projections 251a, 252a are ridges extending in an arc-like manner in the X1-X2 direction.

One of the engagement portions 260a extends in the Z2 direction from the Y1-direction end of the first interlocking member 200a, and the other engagement portion 260a extends in the Z2 direction from the Y2-direction end of the first interlocking member 200a. The engagement portions 260a are each provided with a recess 261a (corresponding to the first recess of the first interlocking member in the claims). The recesses 261a extend in the Z1-Z2 direction, pass through the engagement portions 260a in the Y1-Y2 direction, and open in the Z2 direction.

As best illustrated in FIG. 3B, the second interlocking member 200b extends in the X1-X2 direction and is movable in an arc-like manner in the Y1-Y2 direction in accordance with movement in the Y1-Y2 direction of the operation lever 100. The second interlocking member 200b is placed on top of the first interlocking member 200a. The second interlocking member 200b includes an elongated hole 210b, an abuttable face 220b, guide faces 231b and 232b, guide projections 241b and 242b, and a pair of engagement portions 250b.

The abuttable face 220b is the lower face (Z2-direction end face) of the second interlocking member 200b. The abuttable face 220b extends in an arc-like manner in the X1-X2 direction. The abuttable face 220b abuts the support face 220a of the first interlocking member 200a. In other words, the second interlocking member 200b placed on the first interlocking member 200a is supported by the first interlocking member 200a. This arrangement allows the second interlocking member 200b to move in the Z2 direction in accordance to the movement in the Z2 direction of the first interlocking member 200a.

The elongated hole 210b is a generally rectangular hole passing through the second interlocking member 200b in the Z1-Z2 direction and extends in the X1-X2 direction. The elongated hole 210b is slightly larger in Y1-Y2 direction dimension than the shaft 112 of the operation lever 100. The shaft 112 of the operation lever 100 is inserted through the elongated hole 210b so as to be movable in the Z1-Z2 and X1-X2 directions. In other words, the shaft 112 of the operation lever 100 passes through the second interlocking member 200b in the Z1-Z2 direction. The elongated hole 210b of the second interlocking member 200b has a Y1-direction inner wall and a Y2-direction inner wall facing the shaft 112 of the operation lever 100 in contact therewith or with narrow clearances therefrom. When the operation lever 100 is located at the neutral position, the shaft 112 of the operation lever 100 regulates the positions of the Y1-direction inner wall and the Y2-direction inner wall of the second interlocking member 200b so as to maintain the second interlocking member 200b in its initial position. When the shaft 112 presses the Y1-direction inner wall, the second interlocking member 200b is displaced from the initial position in the Y1 direction in an arc-like manner. When the shaft 112 presses the Y2-direction inner wall, the second interlocking member 200b is displaced from the initial position in the Y2 direction in an arc-like manner.

The guide face 231b is the X1-direction end face of the second interlocking member 200b. The guide face 232b is the X2-direction end face of the second interlocking member 200b. The guide projection 241b is provided on the guide face 231b. The guide projection 242b is provided on the guide face 232b. The guide projections 241b, 242b are ridges extending in an arc-like manner in the Y1-Y2 direction.

One of the engagement portions 250b extends in the Z2 direction from the X1-direction end of the second interlocking member 200b, and the other engagement portion 250b extends in the Z2 direction from the X2-direction end of the second interlocking member 200b. The engagement portions 250b are each provided with a recess 251b (corresponding to the second recess of the second interlocking member in the claims). The recesses 251b extend in the Z1-Z2 direction, pass through the engagement portions 250b in the X1-X2 direction, and open in the Z2 direction.

The first sliders 300a are best illustrated in FIG. 3B. One of the first sliders 300a is disposed on the Y1-direction end portion of the board body 710 so as to be movable in the X1-X2 direction. The other first slider 300a is disposed on the Y2-direction end portion of the board body 710 so as to be movable in the X1-X2 direction. Each of the first sliders 300a includes a slider body 310a, a pair of arms 320a, a wall 330a, and a projection 340a (corresponding to the first projection of the first slider in the claims). The slider body 310a is a block generally of trapezoidal shape in plan view. The slider main body 310a has an upper face (Z1-direction end face), a lower face (Z2-direction end face), an inner face (face corresponding to the upper/shorter base of the trapezoidal slider body 310a), and an outer face (face corresponding to the lower/longer base of the trapezoidal slider body 310a). The lower face of the slider body 310a has a housing recess 311a (see FIG. 2B). The arms 320a, generally L-shaped in plan view, extend from the respective outer faces of the sider body 310a, with the tips of the arms 320a facing each other. The tips of the arms 320a are inserted into a spring 910a (to be described) of each first return mechanism 900a from the opposite ends of the spring 910a. In other words, the spring 910a is held between the arms 320a.

The wall 330a stands on the upper face of the slider body 310a. The wall 330a has an inner face, which faces in the same direction as the inner face of the slider main body 310a. The projection 340a extends in the Y1-Y2 direction from the inner face of the wall 330a. The projection 340a is engaged in the recess 261a of the engagement portion 260a of the associated first interlocking member 200a so as to be movable in the Z1-Z2 direction relative to the recess 261a. When the associated first interlocking member 200a moves in the X1-X2 direction, the engagement portion 260a presses the projection 340a to move the first slider 300a in the X1-X2 direction.

The second sliders 300b are best illustrated in FIG. 3B, One of the second sliders 300b is disposed on the X1-direction end portion of the board body 710 so as to be movable in the Y1-Y2 direction. The other second slider 300b is disposed on the X2-direction end portion of the board body 710 so as to be movable in the Y1-Y2 direction. Each of the second sliders 300b has the same configuration as the first slider 300a and accordingly includes a slider body 310b, a pair of arms 320b, a wall 330b, and a projection 340b (corresponding to the second projection of the second slider in the claims). The projection 340b is engaged in the recess 251b of the engagement portion 250b of the associated second interlocking member 200b so as to be movable in the Z1-Z2 direction relative to the recess 251b. When the associated second interlocking member 200b moves in the Y1-Y2 direction, the engagement portion 250b presses the projection 340b to move the second slider 300b in the Y1-Y2 direction. The tips of the arms 320b are inserted into a spring 910b (to be described) of each second return mechanism 900b from opposite ends of the spring 910b. In other words, the spring 910b is held between the arms 320b.

The first detector 800a is used to detect directions and amounts of movements of the first interlocking member 200a by detecting directions and amounts of movements of the Y2-direction-side one of the first sliders 300a. In the first embodiment, the first detector 800a illustrated in FIG. 2B is a variable resistor used to detect directions and amounts of movements of the Y2-direction-side first slider 300a as changes in electrical resistance. The first detector 800a includes a contactor 810a, a resistor (not shown), and a conductor (not shown). The resistor and the conductor are formed on the Y2-direction end portion of the board body 710. The resistor and the conductor generally extend in the X1-X2 direction in parallel to each other. The contactor 810a is fixed to the top face (Z1-direction face) of the housing recess 311a of the Y2-direction-side first slider 300a to be housed inside the housing recess 311a. The contactor 810a is in contact with the resistor and the conductor to electrically conduct the resistor and the conductor. The contactor 810a can slide on and along the resistor and the conductor in accordance with movements in the X1-X2 direction of the Y2-direction-side first slider 300a. When the contactor 810a slides on the resistor and the conductor, the electrical resistance in the first detector 800a changes.

The second detector 800b is used to detect directions and amounts of movements of the second interlocking member 200b by detecting directions and amounts of movements of the X1-direction-side one of the second sliders 300b. In the first embodiment, the second detector 800b illustrated in FIG. 2A is a variable resistor used to detect directions and amounts of movements of the X1-direction-side second slider 300b as changes in electrical resistance. The second detector 800b includes a contactor 810b, a pair of resistors (not shown), and a conductor (not shown). The resistors and the conductor are formed on the X1-direction end portion of the board body 710. The resistors and the conductor extend in the Y1-Y2 direction. The contactor 810b is fixed to the top face (Z1-direction face) of the housing recess 311b of the X1-direction-side second slider 300b to be housed inside the housing recess 311b. The contactor 810b is in contact with the resistors and the conductor to electrically conduct the resistors and the conductor. The contactor 810b can slide on and along the resistors and the conductor in response to movements in the Y1-Y2 direction of the X1-direction-side second slider 300b. When the contactor 810b slides on the resistors and the conductor, the electrical resistance in the second detector 800b changes.

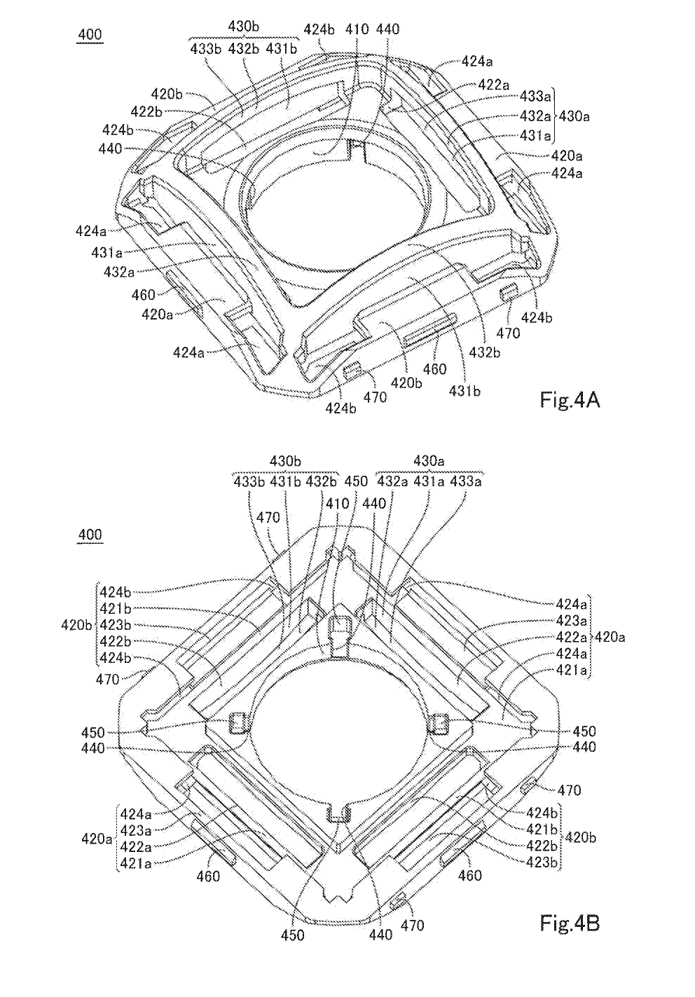

The body 400 is made of an insulating resin. The body 400 is disposed on the board body 710 of the circuit board 700. As best illustrated in FIGS. 4A and 4B, the body 400 includes an opening 410, a pair of first housing portions 420a, a pair of second housing portions 420b, a pair of first guides 430a, a pair of second guides 430b, four guide holes 440, four engagement holes 450, four engagement projections 460, and four engagement projections 470.

The engagement projections 460 are each provided on each one of the four outer faces of the body 400. Two of the engagement projections 470 are provided on the X1-direction outer face of the body 400 to be located on opposite sides of the one of the engagement projection 460. The other two engagement projections 470 are provided on the X2-direction outer face of the body 400 to be located on opposite sides of the other engagement projection 460.

The opening 410 is a columnar hole passing through the central portion of the body 400 in the Z1-Z2 direction. The opening 410 has a diameter that is slightly larger than the outer diameter of the mount 600. The four guide holes 440 are formed around the opening 410 of the body 400 at approximately 90° intervals. The guide holes 440 pass through the surrounding area of the opening 410 of the body 400 in the Z1-Z2 direction and communicate with the opening 410. The opening 410 receive the mount 600 movably in the Z1-Z2 direction. The guide holes 440 receive the guide projections 620 of the mount 600 movably in the Z1-Z2 direction to suppress wobbling the mount 600. The four engagement holes 450 are bottomed holes in the lower face (Z2-direction end face) of the body 400 and located on the outside of and in communication with the respective guide holes 440.

The first housing portions 420a house the respective first sliders 300a movably in the X1-X2 direction. One of the first housing portions 420a is provided along the Y1-direction end portion of the body 400, and the other first housing portion 420a is provided along the Y2-direction end portion of the body 400. One of the first housing portions 420a has a lower track 421a, an upper track 422a, a spring hole 423a, and a pair of slits 424a.

As best illustrated in FIG. 4B, the lower track 421a is a bottomed hole extending in the X1-X2 direction in the Y1-direction end portion of the lower face of the body 400. The lower track 421a is larger in X1-X2 direction dimension and slightly larger in the Y1-Y2 direction dimension than the slider body 310a of the first slider 300a. The lower track 421a receives the slider body 310a movably in the X1-X2 direction.

The upper track 422a is formed centrally in the ceiling (Z1-direction face) of the lower track 421a of the body 400. The upper track 422a is a hole extending in the X1-X2 direction so as to communicate with the lower track 421a and open in the Z1 direction. The upper track 422a is smaller in X1-X2 direction dimension than the lower track 421a. The upper track 422a receives the lower portion of the wall 330a of the first slider 300a movably in the X1-X2 direction.

The spring hole 423a is a bottomed hole extending in the X1-X2 direction in the lower face of the body 400, more particularly on the Y1 direction side of the Y1-direction-side one of the lower track 421a of the body 400. The spring hole 423a is smaller in X1-X2 direction dimension (longitudinal direction dimension) and slightly larger in the Y1-Y2 direction dimension (short direction dimension) than of the spring 910a of each first return mechanisms 900a. The spring hole 423a houses the spring 910a in a compressed state and the tips of the pair of arms 320a of the first slider 300a as received in the spring 910a.

The slits 424a are provided on opposite sides in the X1-X2 direction of the spring hole 423a of the body 400. The slits 424a extend in the X1-X2 direction, communicate with the spring hole 423a and the lower track 421a, and open in the Z1 direction. The slits 424a receive the respective basal end portions of the arms 320a of the first slider 300a movably in the X1-X2 direction.

The other first housing portion 420a has a similar configuration as the one of the first housing portions 420a. The differences are that the other first housing portion 420a is provided in a different portion of the body 400 as described above and is a mirror image in the Y1-Y2 direction. Accordingly, detailed descriptions will not be provided.

The first guides 430a guide the first interlocking member 200a to move in the X1-X2 direction in an arc-like manner. One of the first guides 430a is located at the Z1-direction side relative to the one of the first housing portions 420a (located above the level of the one of the first housing portions 420a). The other first guide 430a is located at the Z1-direction side relative to the other first housing portion 420a (located above the level of the other first housing portion 420a). The one of the first housing portions 420a includes a wall 431a, a ridge 432a, and a space 433a. The wall 431a extends in the Z1-Z2 direction from the Y1-direction wall of the upper track 422a of the one of the first housings 420a. The Z1-direction end of the wall 431a is provided with the ridge 432a, which an arc-shaped ridge convexed in the Y2 direction.

The wall 431a and the ridge 432a define the space 433a, which is located on the Z1-direction side the upper track 422a and communicates with the upper track 422a. The space 433a open inward (in the Y2 direction). The upper part of the wall 330a of the first slider 300a is housed movably in the X1-X2 direction inside the space 433a and the upper track 422a. The projection 340a of the associated first slider 300a projects inward (in the Y2 direction) through the space 433a to be engaged with the recess 261a of each engagement portion 260a of the first interlocking member 200a. The ridge 432a has an arc-shaped lower face corresponding to the arc-shaped route of the guide projection 251a of the first interlocking member 200a. The ridge 432a serves to guide the guide projection 251a movably in an arc-like manner in the X1-X2 direction. The inner face of the ridge 432a faces the guide face 241a of the first interlocking member 200a to guide the guide face 241a movably in the X1-X2 direction.

The other first guide 430a has a similar configuration as the one of the first guide 430a. The differences are that the other first guide 430a is provided in a different portion on the body 400 and an mirror-image the Y1-Y2 direction. Accordingly, detailed descriptions will not be provided. The ridge 432a of the other first guide 430a has an arc-shaped lower face corresponding to the arc-shaped route of the guide projection 252a of the first interlocking member 200a. The ridge 432a serves to guide the guide projection 252a movably in an arc-like manner in the X1-X2 direction. The inner face of the ridge 432a faces the guide face 242a of the first interlocking member 200a to guide the guide face 242a movably in the X1-X2 direction.

The second housing portions 420b house the respective second sliders 300b movably in the Y1-Y2 direction. One of the second housing portions 420b is provided in the X1-direction end portion of the body 400, and the other second housing portion 420b is provided in the X2-direction end portion of the body 400. The second housing portions 420b have a similar configuration as the first housing portions 420a described above and accordingly will not be described with regarding the overlapping features. The second housing portions 420b each include a lower track 421b, an upper track 422b, a spring hole 423b, and a pair of slits 424b. The lower track 421b of the one of the second housing portions 420b communicates with the X1-direction ends of both of the lower tracks 421a. The lower track 421b of the other second housing portion 420b communicates with the X2-direction ends of both of the lower tracks 421a. In short, the four lower tracks 421a and 421b form a square frame-like recess.

The second guides 430b guide the second interlocking member 200b to move in the Y1-Y2 direction in an arc-like manner. One of the second guides 430b is located at the Z1-direction side relative to the one of the second housing portions 420b (located above the level of the one of the second housing portions 420b). The other second guide 430b is located at the Z1-direction side relative to the other second housing portion 420b (located above the level of the other second housing portion 420b). The second guides 430b each include a wall 431b, a ridge 432b, and a space 433b. The wall 431b of each of second guides 430b has the same configuration as the wall 431a of each of the first guides 430a, except that the wall 431b is larger in Z1-Z2 direction than the wall 431a. Accordingly, descriptions will not be provided with regard to features of the wall 431b overlapping with those of the wall 431a. The ridge 432b of each of the second guides 430b has the same configuration as the ridge 432a of each of the first guides 430a, except that the ridge 432b has an arc-shaped lower face corresponding to the arc-shaped route of the guide projection 241b or 242b of the second interlocking member 200b. Accordingly, descriptions will not be provided with regard to features of the ridge 432b overlapping with those of the ridge 432a.

As best illustrated in FIG. 1A, the cover 500a is attached to the body 400 to partially cover the first and second interlocking members 200a, 200b. The cover 500a has an opening 510a and four engagement holes 520a. The opening 510a is a generally rectangular hole passing through the apex area of the cover 500a. As illustrated in FIGS. 2A and 2B, the opening 510a receives therethrough the shaft 112 of the operation lever 100. Two of the engagement holes 520a are provided in the X1-direction outer wall of the cover 500a and engaged with the respective engagement projections 470 on the X1-direction side of the body 400. The other two engagement holes 520a are provided in the X2-direction outer wall of the cover 500a and engaged with the respective engagement projections 470 on the X2-direction side of the body 400.

As best illustrated in FIG. 1B, the frame 500b is a generally rectangular metal plate disposed under the board body 710. The frame 500b includes four engagement pieces 510b and four engagement pieces 520b. The engagement pieces 510b are disposed in the central portion of the frame 500b at 90° intervals. The engagement pieces 510b pass through the board body 710 to be engaged with the respective engagement holes 450 of the body 400. The engagement pieces 520b are disposed on the respective four sides of the frame 500b. The engagement pieces 520b are each provided with an engagement hole. Each engagement holes is engaged with each engagement projection 460 of the body 400.

The first return mechanisms 900a elastically hold the respective first sliders 300a in the X1-X2 direction in order to maintain the operation lever 100 at the neutral position. As best illustrated in FIG. 2D, the first return mechanisms 900a each include a spring 910a, a pair of stops 921a, and a pair of stops 922a. The spring 910a is held by the pair of arms 320a of the associated first slider 300a and housed, together with the arms 320a, in the spring hole 423a of the associated first housing portion 420a of the body 400. One of the stops 921a, which is the X1-direction wall of the associated spring hole 423a, abuts the X1-direction end of the associated spring 910a. The other stop 921a, which is the X2-direction wall of the associated spring hole 423a, abuts the X2-direction end of the associated spring 910a. The stops 922a are protrusions on the cover 500a, provided in spaced relation in the X1-X2 direction. One of the stops 922a is received in the slit 424a on the X1-direction side of the associated first housing 420a of the body 400 and abuts the X1-direction end of the associated spring 910a. The other stop 922a is received in the slit 424a on the X2-direction side of the same first housing 420a and abuts the X2-direction end of the same spring 910a. Each spring 910a attached to the arms 320a of each first slider 300a is thus held by two sets of stops 921a and 922a and thereby elastically holds each first slider 300a in the X1-X2 direction.

When each first slider 300a moves in the X1 direction, each spring 910a is compressed between the arm 320a on the X2-direction side and the stops 921a, 922a on the X1-direction side. The compressed springs 910a exerts a biasing force to allow the first slider 300a to move in the X2 direction back to its original position. When each first slider 300a moves in the X2 direction, each spring 910a is compressed between the arm 320a on the X1-direction side and the stops 921a, 922a on the X2-direction side. The compressed springs 910a exerts a biasing force to allow the first slider 300a to move in the X1 direction back to its original position.

The second return mechanisms 900b elastically hold the respective second sliders 300b in the Y1-Y2 direction in order to maintain the operation lever 100 at the neutral position. As best illustrated in FIG. 2E, the second return mechanisms 900b each include a spring 910b, a pair of stops 921b, and a pair of stops 922b. The spring 910b is held by the pair of arms 320b of the associated second slider 300b. The spring 910b as compressed is housed, together with the arms 320b, in the spring hole 423b of the associated second housing portion 420b of the body 400. One of the stops 921b, which is the Y1-direction wall of the associated spring hole 423b, abuts the Y1-direction end of the associated spring 910b. The other stop 921b, which is the Y2-direction wall of the associated spring hole 423b, abuts the Y2-direction end of the associated spring 910b. The stops 922b are protrusions on the cover 500a, provided in spaced relation in the Y1-Y2 direction. One of the stops 922b is received in the slit 424b on the Y1-direction side of the associated second housing 420b of the body 400 and abuts the Y1-direction end of the associated spring 910b. The other stop 922b is received into the slit 424b on the Y2-direction side of the same second housing 420b and abuts the Y2-direction end of the same spring 910b. Each spring 910b attached to the arms 320b of each second slider 300b is thus held by two sets of stops 921b and 922b and thereby elastically holds each second slider 300b in the Y1-Y2 direction.

When each second slider 300b moves in the Y1 direction, each spring 910b is compressed between the arm 320b on the Y2-direction side and the stops 921b, 922b on the Y1-direction side. The compressed springs 910b exerts a biasing force to allow the second slider 300b to move in the Y2 direction back to its original position. When each second slider 300b moves in the Y2 direction, each spring 910b is compressed between the arm 320b on the Y1-direction side and the stops 921b, 922b on the Y2-direction side. The compressed springs 910b exerts a biasing force to allow the second slider 300b to move in the Y1 direction back to its original position.

The multidirectional input device configured as described above may be assembled in the following manner. First, the first interlocking member 200a and the body 400 are prepared. The guide projections 251a, 252a of the first interlocking member 200a are inserted into the respective spaces 433a of the first guides 430a of the body 400, and the guide projections 251a, 252a are brought into abutment with the lower faces of the ridges 432a of the first guides 430a. The second interlocking member 200b is also prepared. The guide projections 241b, 242b of the second interlocking member 200b are inserted into the respective spaces 433b of the second guides 430b of the body 400, and the guide projections 241b, 242b are brought into abutment with the lower faces of the ridges 432b of the second guides 430b. As a result, the second interlocking member 200b abuts on the support face 220a of the first interlocking member 200a, so that the first interlocking member 200a is disposed on top of and in substantially orthogonal orientation to the first interlocking member 200a.

The cover 500a is also prepared. The body 400 is inserted into the cover 500a and the engagement projections 470 of the body 400 are brought into engagement with the respective engagement holes 520a of the cover 500a. The body 400 is thus attached to the cover 500a.

Also prepared are the key top 110 and the slidable part 120 of the operation lever 100. The shaft 112 of the key top 110 is inserted from the opening 510a of the cover 500a into the elongated hole 210b of the second interlocking member 200b and the elongated hole 210a of the first interlocking member 200a. Then, the shaft 121 of the slidable part 120 is inserted into the elongated hole 210a of the first interlocking member 200a and is fixed to the shaft 112. The attachment member 130 is also prepared. The attachment member 130 is inserted through the through-hole 123 of the slidable part 120 and screwed with the attachment hole 112a of the shaft 112. Accordingly, the support 122 of the slidable part 120 abuts on the abuttable face 230a of the first interlocking member 200a, thereby preventing the operation lever 100 from dropping off in the Z1 direction.

Then, the mount 600 is housed inside the opening 410 of the body 400, while the guide projections 620 of the mount 600 are inserted into the respective guide holes 440 of the body 400. The mount 600 is thus arranged movably in the Z1-Z2 direction inside the opening 410 of the body 400, and the support face 610 of the mount 600 abuts on the slidable part 120 of the operation lever 100. As a result, the support 122 of the slidable part 120 is sandwiched between the support face 610 of the mount 600 and the abuttable face 230a of the first interlocking member 200a.

Also prepared are the first and second sliders 300a, 300b and the springs 910a, 910b. The contactor 810a of the first detector 800a is adhered onto the housing recess 311a of one of the first slider 300a, and the contactor 810b of the second detector 800b is adhered onto the housing recess 311b of one of the second slider 300b. The tips of the arms 320a of each of the first sliders 300a are inserted from the opposite sides thereof into each spring 910a. The tips of the arms 320b of each of the second sliders 300b are inserted from the opposite sides thereof into each spring 910b.

Then, the arms 320a of the first sliders 300a are inserted into the associated slits 424a of the first housing portion 420a of the body 400. Accordingly, the springs 910a are housed in the respective spring holes 423a of the first housing portions 420a and abuts on the stops 921a, 922a; the walls 330a of the first sliders 300a pass through the respective lower tracks 421a and then inserted into the respective upper tracks 422a and the spaces 433a; the projections 340a respectively pass through the lower tracks 421a and the upper tracks 422a of the first housing portions 420a and the spaces 433 so as to be engaged with the respective recesses 261a of the first interlocking member 200a. Consequently, the first sliders 300a and the springs 910a are housed in the associated first housing portions 420a of the body 400. Similarly, the second sliders 300b and the springs 910b are housed in the respective second housing portions 420b of the body 400.

The elastic member 900c is also prepared. An end of the elastic member 900c is inserted into the ring hole 640 of the mount 600. Also prepared are the circuit board 700, on which the movable contact 810c of the third detector 800c is fixed, and the frame 500b. The board body 710 of the circuit board 700 and the frame 500b are disposed on the body 400, so that the engagement pieces 510b of the frame 500b are engaged with the respective engagement holes 450 of the body 400, and that the engagement projections 460 of the body 400 are engaged with the engagement holes in the engagement pieces 520b of the frame 500b. Consequently, the elastic member 900c is interposed between the board body 710 and the mount 600 to support the mount 600 in midair; the protrusion 630 of the mount 600 is located above the apex of the movable contact 810c of the third detector 800c; and the contactors 810a, 810b of the first and second detectors 800a, 800b are in contact with the associated resistors and the associated conductors. The multidirectional input device is now completely assembled.

The assembled multidirectional input device may be used with each constituent operating in the following manner. When the operation lever 100 at the neutral position is operated in the X1 direction, the operation lever 100 slides on and along the support face 610 of the mount 600. During this slide, the shaft 112 of the operation lever 100 moves in the X1 direction within the elongated hole 210b of the second interlocking member 200b. On the other hand, the first interlocking member 200a is pressed in the X1 direction by the shafts 112, 121 of the operation lever 100 and thereby moves in the X1 direction in an arc-like manner along the support face 610. During this movement, the guide projections 251a, 252a of the first interlocking member 200a are respectively guided by the lower faces of the ridges 432a of the first guides 430a of the body 400, and the guide faces 241a, 242a of the first interlocking member 200a are respectively guided by the inner faces of the ridges 432a of the first guides 430a.

The movement in the X1 direction of the first interlocking member 200a causes their the engagement portions 260a to press the projections 340a of the first sliders 300a in the X1 direction. The first sliders 300a accordingly move in the X1 direction against the biasing forces of the springs 910a. Simultaneously, the projections 340a move in the Z1-Z2 direction relatively within the respective recesses 261a of the engagement portions 260a; and the contactor 810a of the first detector 800a slides on the resistor and the conductor so as to change the electrical resistance in the first detector 800a. In other words, the first detector 800a detects the direction and amount of movement of the associated first slider 300a as the direction and amount of movement of the first interlocking member 200a. The resistance change is forwarded through the connection portion 720 of the circuit board 700 out to e.g. a control part of an electronic device, which detects the resistance change as the direction and amount of movement of the operation lever 100. Each spring 910a is compressed between the X2-direction arm 320a of each first slider 300a and the X1-direction stops 921a, 922a.

When the operation lever 100 is released, the springs 910a bias the arms 320a on X2-direction side so as to move the first sliders 300a in the X2 direction back to their initial positions. The projections 340a of the first sliders 300a press the respective engagement portions 260a of the first interlocking member 200a in the X2 direction so as to move the first interlocking member 200a in the X2 direction back to its initial position. The first interlocking member 200a in turn presses the shafts 112, 121 of the operation lever 100 so as to move the operation lever 100 in the X2 direction back to the neutral position. It should be appreciated that when the operation lever 100 is operated in the X2 direction, the constituents of the multidirectional input device operate in a symmetrical manner to the operation in the X1 direction.

When the operation lever 100 at the neutral position is operated in the Y1 direction, the operation lever 100 slides on and along the support face 610 of the mount 600. During this slide, the shafts 112, 121 of the operation lever 100 move in the Y1 direction within the elongated hole 210a of the first interlocking member 200a. On the other hand, the second interlocking member 200b is pressed in the Y1 direction by the shaft 112 of the operation lever 100 and thereby moves in the Y1 direction in an arc-like manner along the support face 610. During this movement, the guide projections 241b, 242b of the second interlocking member 200b are respectively guided by the lower faces of the ridges 432b of the second guides 430b of the body 400, and the guide faces 231b, 232b of the second interlocking member 200b are respectively guided by the inner faces of the ridges 432b of the second guides 430b.

The movement in the Y1 direction of the second interlocking member 200b causes their engagement portions 250b to press the projections 340b of the second sliders 300b in the Y1 direction. The second sliders 300b accordingly move in the Y1 direction against the biasing forces of the springs 910b. Simultaneously, the projections 340b move in the Z1-Z2 direction relatively within the respective recesses 251b of the engagement portions 250b; and the contactor 810b of the second detector 800b slides on the resistors and the conductor so as to change the electrical resistance of the second detector 800b. In other words, the second detector 800b detects the direction and amount of movement of the associated second slider 300b as the direction and amount of movement of the second interlocking member 200b. The resistance change is forwarded through the connection portion 720 of the circuit board 700 out to e.g. a control part of an electronic device, which detects the resistance change as the direction and amount of movement of the operation lever 100. Each spring 910b is compressed between the Y2-direction arm 320b of each second slider 300b and the Y1-direction stops 921b, 922b.

When the operation lever 100 is released, the springs 910b bias the Y2-direction arms 320b so as to move the second sliders 300b in the Y2 direction back to their initial positions. The projections 340b of the second sliders 300b press the respective engagement portions 250b of the second interlocking member 200b in the Y2 direction so as to move the second interlocking member 200b in the Y2 direction back to its initial position. The second interlocking member 200b in turn presses the shaft 112 of the operation lever 100 so as to move the operation lever 100 in the Y2 direction back to the neutral position. It should be appreciated that when the operation lever 100 is operated in the Y2 direction, the constituents of the multidirectional input device operate in a symmetrical manner to the operation in the Y1 direction.

When the operation lever 100 at the neutral position is operated in a direction including an X1- and Y1-direction components, the constituents of the device operate in the same manner as when the operation lever 100 moves in the X1 direction and when it moves in the Y1 direction as described above. Resistance changes in the first and second detectors 800a, 800b are forwarded through the connection portion 720 of the circuit board 700 to a control part of an electronic device, which detects the received resistance changes as the direction and amount of movement of the operation lever 100.

When the operation lever 100 at the neutral position is operated in a direction including X1-direction and Y2-direction components, the constituents of the device operate in the same manner as when the operation lever 100 moves in the X1 direction and when it moves in the Y2 direction as described above. Resistance changes in the first and second detectors 800a, 800b are forwarded through the connection portion 720 of the circuit board 700 to a control part of an electronic device, which detects the received resistance changes as the direction and amount of movement of the operation lever 100.

When the operation lever 100 at the neutral position is operated in a direction including X2-direction and Y1-direction components, the constituents of the device operate in the same manner as when the operation lever 100 moves in the X2 direction and when it moves in the Y1 direction as described above. Resistance changes in the first and second detectors 800a, 800b are forwarded through the connection portion 720 of the circuit board 700 to a control part of an electronic device, which detects the received resistance changes as the direction and amount of movement of the operation lever 100.

When the operation lever 100 at the neutral position is operated in a direction including X2-direction and Y2-direction components, the constituents of the device operate in the same manner as when the operation lever 100 moves in the X2 direction and when it moves in the Y2 direction as described above. Resistance changes in the first and second detectors 800a, 800b are forwarded through the connection portion 720 of the circuit board 700 to a control part of an electronic device, which detects the received resistance changes as the direction and amount of movement of the operation lever 100.

When the operation lever 100 at the neutral position is pressed in the Z2 direction, the operation lever 100 presses the mount 600 in the Z2 direction. The pressed mount 600 moves in the Z2 direction against the biasing force of the elastic member 900c, and the first and second interlocking members 200a, 200b also move in the Z2 direction. Simultaneously, the projections 340a of the first sliders 300a move in the Z1 direction relatively within the respective recesses 261a of the first interlocking member 200a. The projections 340b of the second sliders 300b move relatively in the Z1 direction inside the respective recesses 251b of the second interlocking member 200b. The guide projections 251a, 252a of the first interlocking member 200a move away from the ridges 432a of the first guides 430a in the Z2 direction. The guide projections 241b, 242b of the second interlocking member 200b move away from the ridges 432b of the second guides 430b in the Z2 direction.

The movement in the Z2 direction of the mount 600 causes its protrusion 630 to depress the apex of the movable contact 810c of the third detector 800c. The depressed movable contact 810c elastically deforms and makes contact with the first stationary contact. This brings the first and second stationary contacts into conduction, allowing the third detector 800c to detect the operation in the Z2 direction of the operation lever 100.

The multidirectional input device described above has at least the following technical features. First, the device provides an improved operational feel of the operation lever 100 for the following reasons. The operation lever 100 slides on the generally spherically convexed support face 610 of the mount 600, so that the operation lever 100 can move along a longer route (rotate at a longer radius). Further, the protrusion 122a of the operation lever 100 slides on the support face 610 of the mount 600, reducing friction between the operation lever 100 and the support face 610.

Second, the multidirectional input device can detect operations of the operation lever 100 with improved accuracy for the following reasons. The first and second interlocking members 200a, 200b can move in an arc-like manner in accordance with movement of the operation lever 100, so that they each can move along a longer route (rotate at a longer radius). This advantage will not be impaired even when the multidirectional input device is downsized or thinned. Particularly, because of a shorter distance to the operable portion 111 of the operation lever 100, the first and second interlocking members 200a, 200b can move along a sufficiently long route (rotate at a sufficiently long radius). Therefore, the multidirectional input device is suitable for downsizing and thinning.

Third, the multidirectional input device has an advantageously small dimension in the Z1-Z2 direction for the following reasons. The second interlocking member 200b is placed on the support face 220a of the first interlocking member 200a, leaving no gap between the first interlocking member 200a and the second interlocking member 200b. Further, the springs 910a, 910b are oriented horizontally in the spring holes 423a, 423b.

Fourth, arc-like movements of the first and second interlocking members 200a, 200b will not apply load to the part connecting between the first interlocking member 200a and the first sliders 300a (i.e. to the recesses 261a and the projections 340a) or to the part connecting between the second interlocking member 200b and the second sliders 300b (i.e. to the recesses 251b and the projections 340b). This is because the recesses 261a, 251b extend in the Z1-Z2 direction, and the projections 340a, 340b are respectively engaged in the recesses 261a, 251b movably in the Z1-Z2 direction. Fifth, it is easy to couple the first sliders 300a to the first interlocking member 200a and the second sliders 300b to the second interlocking member 200b, only requiring engagement of the projections 340a, 340b with the recesses 261a, 251b, respectively.

Sixth, the first and second interlocking members 200a, 200b can move in a stable manner for the following reasons. The guide projections 251a, 252a of the first interlocking member 200a are guided movably in the X1-X2 direction in an arc-like manner by the first guides 430a of the body 400, and the guide faces 241a, 242a of the first interlocking member 200a are also guided movably in the X1-X2 direction by the first guides 430a. Further, the guide projections 241b, 242b of the second interlocking member 200b are guided movably in the Y1-Y2 direction in an arc-like manner by the second guides 430b of the body 400, and the guide faces 231b, 232b of the second interlocking member 200b are also guided movably in the Y1-Y2 direction by the second guides 430b.

Seventh, the multidirectional input device can be fabricated with a reduced number of components for the following reasons. The first and second guides 430a, 430b of the body 400 regulate the movements of the first and second interlocking members 200a, 200b. The first and second housing portions 420a, 420b of the body 400 regulate the movements of the first and second sliders 300a, 300b. The opening 410 of the body 400 regulates the movement of the mount 600. Accordingly, these movement regulations are provided for in the multidirectional input device without adding separate components for this purpose.

The multidirectional input device of the invention is not limited to the configuration of the above embodiment but may be modified in any manner within the scope of the claims. Specific modification examples will be described in detail below.

The mount of the invention may be modified in any manner as long as it has a generally spherically convexed support face to support an operation lever slidably. For example, the mount may be provided on a circuit board or a body. The mount may also be integrated with the body.

The operation lever of the invention may be modified in any manner as long as it is slidably supported on the support face of the mount. The operation lever of the invention may be provided without the operable portion, the slidable part and/or the attachment member. The operable portion of the operation lever of the invention may be of any shape. The slidable part of the operation lever of the invention may be modified in any manner as long as it is placed slidably on the support face of the mount. For example, the slidable part may have a generally spherically concaved end face that is slidable on and along the support face of the mount. The slidable part may have an end face with a plurality of protrusions that are slidable on and along the support face of the mount. The support of the operation lever may be a separate component from the slidable part. The support may be provided on the shaft of the operation lever so as to be interposed between the first interlocking member and the mount. This modified support may be disposed in spaced relation to the mount. The attachment member of the operable portion of the invention may any member configured to attach the slidable part to the shaft. The attachment member may comprise a pin, an adhesive, a welding material, and/or a snap-fit mechanism.

The first interlocking member of the invention may be modified in any manner as long as it is configured to receive therethrough the operation lever of any of the above aspects and movable in a first direction in an arc-like manner in accordance with movement in the first direction of the operation lever. For example, the first interlocking member may be configured to receive therethrough the operation lever, be supported on the support face of the mount, and slidable in the first direction in an arc-like manner along the support face in accordance with the movement in the first direction of the operation lever. Alternatively, the first interlocking member may be configured to receive therethrough the operation lever, be supported on the first guide of the body moveably in the first direction in an arc-like manner in accordance with movement in the first direction of the operation lever. This modified first interlocking member may be disposed in spaced relation to the support face of the mount, or on the support face of the mount in a slidable manner. The first interlocking member of the invention may be provided without the support face, the abuttable face, the guide faces, the guide projections and/or the engagement portions. Any of the above modified first interlocking members may include a support face, an abuttable face, a guide face, a guide projection and/or an engagement portion.

The second interlocking member of the invention may be modified in any manner as long as it is configured to cross the first interlocking member of any of the above aspects, receive therethrough the operation lever of any of the above aspects, and be movable in a second direction in an arc-like manner in accordance with movement in the second direction of the operation lever. For example, the second interlocking member may be configured to cross the first interlocking member of any of the above aspects, receive therethrough the operation lever of any of the above aspects, and be slidable in the second direction in an arc-like manner on and along the support face of the first interlocking member in accordance with movement in the second direction of the operation lever. Alternatively, the second interlocking member may be configured to cross the first interlocking member of any of the above aspects, receive therethrough the operation lever of any of the above aspects, and be supported on the second guide of the body movably in the second direction in an arc-like manner in accordance with movement in the second direction of the operation lever. This modified second interlocking member may be disposed in spaced relation to the first interlocking member, or on the support face of the first interlocking member in a slidable manner. The second interlocking member may be provided without the abuttable face, the guide faces, the guide projections and/or the engagement portions. Any of the above modified second interlocking members may include a support face, an abuttable face, a guide face, a guide projection and/or an engagement portion.

At least one engagement portion of the first interlocking member of the invention may include a first projection extending in the second direction, and at least one engagement portion of the second interlocking member may include a second projection extending in the first direction. In this case, at least one first slider may have a first recess extending in a third direction that is substantially orthogonal to the first and second directions, and the first projection may be engaged in the first recess so as to be movable in the third direction. Also, at least one second slider may have a second recess extending in the third direction, and the second projection may be engaged in the second recess so as to be movable in the third direction. The recesses of the engagement portions of the first and second interlocking members of the first embodiment may be provided as bottomed recesses that do not pass through the engagement portions in the second direction and the first direction, respectively. The recesses may alternatively be recesses that are not open in the Z2 direction.

The first guide of the invention may be modified in any manner as long as it can guide the first interlocking member of any of the above aspects movably in the first direction in an arc-like manner. The second guide of the invention may be modified in any manner as long as it can guide the second interlocking member of any of the above aspects movably in the second direction in an arc-like manner. For example, the first and second guides may include ridges that can guide the upper faces of the first and second interlocking members movably in an arc-like manner. Alternatively, the first and second guides may include recesses or projections that can guide portions (e.g. guide projections) of the first and second interlocking members movably in an arc-like manner. The first and second guides of any of the above aspects may be provided on a member other than the body (the cover, for example).

The elastic body of the invention may be omitted. If provided, the elastic body may be modified in any manner as long as it can be interposed between the base and the mount to support the mount in midair. For example, the elastic body may be a rubber body or the movable contact of the third detector. If the operation lever is modified to one that cannot be depressed, the elastic body may be interposed between the base and the mount to support the mount in midair.

The multidirectional input device of the invention may be provided without the first and second sliders, or with at least one first slider and one second slider. The at least one first slider of the invention may be modified in any manner as long as it can move in the first direction in accordance with movement in the first direction of the first interlocking member of any of the above aspects. The at least one second slider of the invention may be modified in any manner as long as it can move in the second direction in accordance with movement in the second direction of the second interlocking member of any of the above aspects.

The first detector of the invention may be modified in any manner as long as it can detect directions and amounts of movements of the first interlocking member or the first slider of any of the above aspects. For example, the first detector may include a movable contact and a plurality of stationary contacts arranged at intervals in the first direction, and the movable contact may move in accordance with movement of the first interlocking member or the first slider to sequentially conduct at least two of the stationary contacts. The first detector may be an optical sensor that can optically detect directions and amounts of movements of the first interlocking member or the first slider, or may be a magnetic sensor that can magnetically detect directions and amounts of movements of the first interlocking member or the first slider.

The second detector of the invention may be modified in any manner as long as it can detect directions and amounts of movements of the second interlocking member or the second slider of any of the above aspects. The second detector may be modified in similar manners to the modifications to the first detector as described above.

The third detector of the invention may be omitted. The third detector of the invention may be modified in any manner as long as it can detect movements in the Z1-Z2 direction of the operation lever. For example, the third detector may be a switch, an optical sensor, or a magnetic sensor. The switch may be a tactile switch or a rubber switch, which can be turned on or off when depressed by the operation lever. The rubber switch may serve dual functions as the third detector and the elastic body. The optical sensor may be any sensor to optically detect movements in the Z1-Z2 direction of the operation lever or the mount. The magnetic sensor may be sensor to magnetically detect movements in the Z1-Z2 direction of the operation lever or the mount.

The first return mechanism of the invention may elastically hold the operation lever of any of the above aspects in the first direction. For example, the first return mechanism may include a first elastic body, interposed between the operation lever and a part of the body on one side in the first direction, and a second elastic body, interposed between the operation lever and a part of the body on the other side in the first direction. The first return mechanism of the invention may elastically hold the first interlocking member or the first slider of any of the above aspects in the first direction in order to maintain the operation lever of any of the above aspects at the neutral position. For example, the first return mechanism may include a first elastic body, interposed between the first interlocking member or the first slider and a part of the body on one side in the first direction, and a second elastic body, interposed between the first interlocking member or the first slider and a part of the body on the other side in the first direction.

The second return mechanism of the invention may elastically hold the operation lever of any of the above aspects in the second direction. For example, the second return mechanism may include a first elastic body, interposed between the operation lever and a part of the body on one side in the second direction, and a second elastic body, interposed between the operation lever and a part of the body on the other side in the second direction. The second return mechanism of the invention may elastically hold the second interlocking member or the second slider of any of the above aspects in the second direction in order to maintain the operation lever of any of the above aspects at the neutral position. For example, the second return mechanism may include a first elastic body, interposed between the second interlocking member or the second slider and a part of the body on one side in the second direction, and a second elastic body, interposed between the second interlocking member or the second slider and a part of the body on the other side in the second direction.

The multidirectional input device of the invention may further include a dust-proof film to cover the cover of any of the above aspects. The frame and/or the circuit board of the invention may be omitted.

It should be appreciated that the materials, shapes, dimensions, numbers, arrangements, and other configurations of the constituents of the multidirectional input device as described above may be modified in any manner if they can perform similar functions. The embodiments and modification examples may be combined with each other in any possible manner. The first direction of the invention may be any moving direction of the first interlocking member. The second direction of the invention may be any direction crossing the first direction. The third direction of the invention may be any direction orthogonal to the first direction and the second direction.

### REFERENCE SIGNS LIST

100: operation lever
   110: key top
   120: slidable part
   130: attachment member
200a: first interlocking member
   210a: elongated hole
   220a: support face
   230a: abuttable face
   241a, 242a: guide face
   251a, 252a: guide projection
   260a: engagement portion
      261a: recess (first recess)
200b: second interlocking member
   210b: elongated hole
   220b: abuttable face
   231b, 232b: guide face
   241b, 242b: guide projection
   250b: engagement portion
      251b: recess (second recess)
300a: first slider
   310a: slider body
   320a: arm
   330a: wall
   340a: projection (first projection)
300b: second slider
   310b: slider body
   320b: arm
   330b: wall
   340b: projection (second projection)
400: body
   410: opening
   420a: first housing portion
   420b: second housing portion
   430a: first guide
   430b: second guide
   440: guide hole
   450: engagement hole
   460, 470: engagement projection
500a: cover
500b: frame
600: mount
700: circuit board
   710: board body (base)
800a: first detector
800b: second detector
800c: third detector
900a first return mechanism
900b: second return mechanism
900c: elastic body

1. A multidirectional input device comprising:
a mount, including a support face of generally spherical convex shape;
an operation lever slidably supported on the support face;
a first interlocking member, configured to receive the operation lever therethrough and be movable in a first direction in an arc-like manner in accordance with movement in the first direction of the operation lever;
a second interlocking member, configured to cross the first interlocking member, receive the operation lever therethrough, and be movable in a second direction in an arc-like manner in accordance with movement in the second direction of the operation lever, the second direction crossing the first direction;
a first detector configured to detect a direction and an amount of movement of the first interlocking member; and
a second detector configured to detect a direction and an amount of movement of the second interlocking member.

2. The multidirectional input device according to claim 1, wherein
the operation lever includes a support disposed between the first interlocking member and the mount,
the first interlocking member is supported on the support of the operation lever and movable in the first direction in an arc-like manner along the support face of the mount,
the first interlocking member has a support face of arc shape extending in the second direction, and
the second interlocking member is slidable in the second direction in an arc-like manner on and along the support face of the first interlocking member.

3. The multidirectional input device according to claim 1, wherein
the first interlocking member is slidable in the first direction in an arc-like manner on and along the support face of the mount,
the first interlocking member has a support face of arc shape extending in the second direction, and
the second interlocking member is slidable in the second direction in an arc-like manner on and along the support face of the first interlocking member.

4. The multidirectional input device according to claim 1, wherein
the second direction is substantially orthogonal to the first direction,
the multidirectional input device further comprises:
a first slider movable in the first direction in accordance with movement of the first interlocking member, the first slider including a first projection extending in the second direction, and
a second slider movable in the second direction in accordance with movement of the second interlocking member, the second slider including a second projection extending in the first direction,
the first interlocking member includes a first recess extending in a third direction, the third direction being substantially orthogonal to the first direction and the second direction,
the first projection of the first slider is engaged in the first recess movably in the third direction,
the second interlocking member includes a second recess extending in the third direction, and
the second projection of the second slider is engaged in the second recess movably in the third direction.

5. The multidirectional input device according to claim 2, wherein
the second direction is substantially orthogonal to the first direction,
the multidirectional input device further comprises:
a first slider movable in the first direction in accordance with movement of the first interlocking member, the first slider including a first projection extending in the second direction, and
a second slider movable in the second direction in accordance with movement of the second interlocking member, the second slider including a second projection extending in the first direction,
the first interlocking member includes a first recess extending in a third direction, the third direction being substantially orthogonal to the first direction and the second direction,
the first projection of the first slider is engaged in the first recess movably in the third direction,
the second interlocking member includes a second recess extending in the third direction, and
the second projection of the second slider is engaged in the second recess movably in the third direction.

6. The multidirectional input device according to claim 3, wherein
the second direction is substantially orthogonal to the first direction,
the multidirectional input device further comprises:
a first slider movable in the first direction in accordance with movement of the first interlocking member, the first slider including a first projection extending in the second direction, and
a second slider movable in the second direction in accordance with movement of the second interlocking member, the second slider including a second projection extending in the first direction,
the first interlocking member includes a first recess extending in a third direction, the third direction being substantially orthogonal to the first direction and the second direction,
the first projection of the first slider is engaged in the first recess movably in the third direction,
the second interlocking member includes a second recess extending in the third direction, and
the second projection of the second slider is engaged in the second recess movably in the third direction.

7. The multidirectional input device according to claim 1, wherein
the second direction is substantially orthogonal to the first direction,
the multidirectional input device further comprises:
a first slider movable in the first direction in accordance with movement of the first interlocking member, the first slider including a first recess extending in a third direction, the third direction being substantially orthogonal to the first direction and the second direction, and
a second slider movable in the second direction in accordance with movement of the second interlocking member, the second slider including a second recess extending in the third direction,
the first interlocking member includes a first projection extending in the second direction,
the first projection of the first interlocking member is engaged in the first recess movably in the third direction,
the second interlocking member includes a second projection extending in the first direction, and
the second projection of the second interlocking member is engaged in the second recess movably in the third direction.

8. The multidirectional input device according to claim 2, wherein
the second direction is substantially orthogonal to the first direction,
the multidirectional input device further comprises:
a first slider movable in the first direction in accordance with movement of the first interlocking member, the first slider including a first recess extending in a third direction, the third direction being substantially orthogonal to the first direction and the second direction, and
a second slider movable in the second direction in accordance with movement of the second interlocking member, the second slider including a second recess extending in the third direction,
the first interlocking member includes a first projection extending in the second direction,
the first projection of the first interlocking member is engaged in the first recess movably in the third direction,
the second interlocking member includes a second projection extending in the first direction, and
the second projection of the second interlocking member is engaged in the second recess movably in the third direction.

9. The multidirectional input device according to claim 3, wherein
the second direction is substantially orthogonal to the first direction,
the multidirectional input device further comprises:
a first slider movable in the first direction in accordance with movement of the first interlocking member, the first slider including a first recess extending in a third direction, the third direction being substantially orthogonal to the first direction and the second direction, and
a second slider movable in the second direction in accordance with movement of the second interlocking member, the second slider including a second recess extending in the third direction,
the first interlocking member includes a first projection extending in the second direction,
the first projection of the first interlocking member is engaged in the first recess movably in the third direction,
the second interlocking member includes a second projection extending in the first direction, and
the second projection of the second interlocking member is engaged in the second recess movably in the third direction.

10. The multidirectional input device according to claim 1, further comprising:
a first guide configured to guide the first interlocking member movably in the first direction in an arc-like manner, and
a second guide configured to guide the second interlocking member movably in the second direction in an arc-like manner.

11. The multidirectional input device according to claim 4, further comprising a body, the body including:
a first housing portion to house the first slider movably in the first direction;
a second housing portion to house the second slider movably in the second direction;
a first guide at one side of the third direction relative to the first housing portion, the first guide being configured to guide the first interlocking member to move in the first direction in an arc-like manner; and
a second guide at one side of the third direction relative to the second housing portion, the second guide being configured to guide the second interlocking member to move in the second direction in an arc-like manner.

12. The multidirectional input device according to claim 7, further comprising a body, the body including:
a first housing portion to house the first slider movably in the first direction;
a second housing portion to house the second slider movably in the second direction;
a first guide at one side of the third direction relative to the first housing portion, the first guide being configured to guide the first interlocking member to move in the first direction in an arc-like manner; and
a second guide at one side of the third direction relative to the second housing portion, the second guide being configured to guide the second interlocking member to move in the second direction in an arc-like manner.

13. The multidirectional input device according to claim 1, further comprising:
a base; and
an elastic body interposed between the base and the mount, the elastic body supporting the mount in midair.

14. The multidirectional input device according to claim 2, further comprising:
a base; and
an elastic body interposed between the base and the mount, the elastic body supporting the mount in midair.

15. The multidirectional input device according to claim 3, further comprising:
a base; and
an elastic body interposed between the base and the mount, the elastic body supporting the mount in midair.

16. The multidirectional input device according to claim 2, further comprising:
a base; and
an elastic body interposed between the base and the mount, the elastic body supporting the mount in midair and providing a biasing force to hold the support of the operation lever between the mount and the first interlocking member.

17. The multidirectional input device according to claim 13, wherein
the operation lever is movable in a third direction so as to depress the mount, the third direction being substantially orthogonal to the first direction and the second direction,
the mount as depressed is movable against an elastic force of the elastic body, and
the multidirectional input device further comprises a third detector configured to detect the movement of the operation lever.

18. The multidirectional input device according to claim 16, wherein
the operation lever is movable in a third direction so as to depress the mount, the third direction being substantially orthogonal to the first direction and the second direction,
the mount as depressed is movable against an elastic force of the elastic body, and
the multidirectional input device further comprises a third detector configured to detect the movement of the operation lever.

19. The multidirectional input device according to claim 4, wherein
the first detector is configured to detect a direction and an amount of movement of the first interlocking member by detecting a direction and an amount of movement of the first slider, and
the second detector configured to detect a moving direction and a moving amount of movement of the second interlocking member by detecting a moving direction and a moving amount of movement of the second slider.

20. The multidirectional input device according to claim 7, wherein
the first detector is configured to detect a direction and an amount of movement of the first interlocking member by detecting a direction and an amount of movement of the first slider, and
the second detector configured to detect a moving direction and a moving amount of movement of the second interlocking member by detecting a moving direction and a moving amount of movement of the second slider.

21. The multidirectional input device according to claim 11, wherein
the first detector is configured to detect a direction and an amount of movement of the first interlocking member by detecting a direction and an amount of movement of the first slider, and
the second detector configured to detect a moving direction and a moving amount of movement of the second interlocking member by detecting a moving direction and a moving amount of movement of the second slider.
